(19) United States
(12) Patent Application Publication
(10) Pub. No.: US 2006/0092145 A1
(43) Pub. Date: May 4, 2006

(54) Pen type optical pointing device

(75) Inventor: In-Gwang Kim, Seoul (KR)

Correspondence Address: BIRCH STEWART KOLASCH & BIRCH, PO BOX 747, FALLS CHURCH, VA, 22040-0747, US

(73) Assignee: PERCEPTCOM INC

(21) Appl. No.: 11/259,121

(22) Filed: Oct. 27, 2005

(30) Foreign Application Priority Data
Oct. 28, 2004 (KR) 10-2004-86838

(51) Int. Cl. G09G 5/00

(52) U.S. Cl. 345/179

(57) ABSTRACT

Disclosed herein is a pen-type optical pointing device. The pen-type optical pointing device detects the moving direction and distance thereof in such a way as to radiate light onto a plane, detect an image of the plane and analyze the difference between a previous image and a current image. The pen-type optical pointing device includes a casing configured for a lower portion thereof to converge toward a central axis thereof, with an opening being provided at a lower end thereof; and an illumination device installed inside the casing, near the opening of the casing and on an acutely inclined side of the casing to have an illumination angle ranging from 15° to 60°. If the pen-type pointing device constructed as described above is employed, the lower-end portion thereof can be reduced while an illumination angle used in existing optical mice can be maintained, so that it is possible to provide a pen-type pointing device having the same size as an existing writing pen.

### BACKGROUND OF THE INVENTION

1. Field of the Invention

The present invention relates to a pen-type optical pointing device.

2. Description of the Related Art

Generally, a variety of optical pointing devices, including a pen-type mouse, detect the moving distances and directions thereof in such a way as to illuminate surfaces using Light Emitting Diodes (LEDs), receive the shapes of the surfaces through lenses in the form of images, and process the images.

In the case where LED illumination light is radiated onto white surfaces or objects having minutely rough surfaces at an angle of about 20°, shadows of the minutely rough surfaces are generated, so that the precise movement of the pointing devices can be detected using more clearly distinguishable image patterns. Accordingly, when light radiated onto the surfaces forms an angle of about 20° with respect to the surfaces, the images of the surfaces input to the optical pointing devices are optimized, so that the optical pointing devices have optimum sensitivity.

Meanwhile, in a conventional pen-type mouse using a tip point 140 (having a diameter of about 1.5 cm) as shown in FIG. 1A, the angle 142 between the illumination direction of an illumination LED 141 and a vertical axis is too small to achieve an optimum illumination angle of 20° with respect to a surface in consideration of the fact that the pen-type mouse is generally used while held inclined at an angle ranging from about 30° to about 40°. Furthermore, in the case where the pen-type mouse is used in an almost vertical position, like the case where the pen-type mouse is used on the palm instead of on a surface, the illumination angle becomes excessively large, thus considerably degrading the sensitivity of the pen-type mouse.

In order to solve the above-described problems, by widening the angle 143 to an angle of about 35° as shown in FIG. 1B, the illumination angle of the LED with respect to the surface is 20°, that is, the optimum angle, in the case where the pen-type mouse is used while generally remaining inclined at an angle within a range from 30° to 40°. Even when the pen-type mouse is used in a vertical position, a somewhat sufficient illumination angle can be ensured. however, in this case, the pen-type mouse must be thick as illustrated well in FIG. 1B, so that it is inconvenient to use the pen-type mouse.

Furthermore, FIGS. 2A and 2B illustrate variation 155 in the distance between a surface (detection region) and the optical mouse sensor when the conventional pen-type mouse equipped with the tip point is used in an inclined position. Reference numeral 151 designates an optical mouse sensor, reference numeral 152 designates an optical lens, reference numeral 153 designates the distance between the central axis of the path of an optical image and the central axis of the tip point, and reference numeral 156 designates the angle between the central axis and the surface. If it is assumed that the inclined angle of the pen-type mouse is 25° and the distance 153 is about 1.5 mm in terms of mechanism design, the difference 155 in distance, that is, 1.5 mm×tan 25°=0.7 mm, becomes considerably long, so that the distortion of an image input through the lens 152 is high, thus degrading the pointing sensitivity of the pen-type mouse.

The conventional pen-type mouse using the tip point is disadvantageous in that the amount of light is reduced in proportion to the length of the tip point.

In order to overcome the disadvantages of the above-described conventional pen-type mouse, in another conventional pen-type mouse, an optical guide is mounted at a location where the tip point is mounted on the first conventional pen-type mouse, as shown in FIGS. 3A and 3B. Reference numeral 180 of FIG. 3A designates the path of light around the lower end of the optical guide, and FIG. 3B illustrates an illumination angle 181 when the pen-type mouse is inclined at an angle of 25° during use.

In this conventional pen-type mouse, it is possible to use the pen-type mouse at an optimum illumination angle when the pen-type mouse is used while held inclined, as shown in FIG. 3A. However, when the pen-type mouse is used in a vertical position, the illumination angle of light becomes almost parallel to the surface, so that the sensitivity of the pen-type mouse is extremely degraded. Accordingly, the structure of FIG. 3 is disadvantageous in that the sensitivity of a pointing operation may be considerably degraded depending on the angle at which the pen-type mouse is inclined during use. The case where a chip LED, instead of the optical guide, is mounted on the side of the tip point is the same.

### SUMMARY OF THE INVENTION

Accordingly, the present invention has been made keeping in mind the above problems of the conventional pen-type pointing device, and an object of the present invention is to provide a pen-type pointing device that has low variation in sensitivity despite variation in use angles and can achieve optimum sensitivity at normal use angles while keeping the thickness of the pen-type pointing device small.

In order to accomplish the above object, the present invention provides a pen-type optical pointing device, the pen-type optical pointing device detecting a moving direction and distance thereof in such a way as to radiate light onto a plane, detect the image of the plane and analyze the difference between a previous image and a current image, including a casing configured for the lower portion thereof to converge toward the central axis thereof, with an opening being provided at the lower end thereof; and an illumination device installed inside the casing, near the opening of the casing and on an acutely inclined side of the casing to have an illumination angle ranging from 15° to 60°.

Additionally, the present invention provides a pen-type optical pointing device, the pen-type optical pointing device detecting a moving direction and distance thereof in such a way as to radiate light onto a plane, detect the image of the plane and analyze a difference between a previous image and a current image, including a casing configured for the lower portion thereof to gradually converge toward the central axis thereof, with an opening being provided at the lower end thereof; and a tip point configured to protrude through a portion of the opening located on a side opposite to a side toward which the pen-type pointing device is inclined, come into contact with the plane at the bottom thereof, and radiate illumination light in a direction opposite to a direction in which the pen-type pointing device is inclined.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams schematically illustrating a conventional pen-type mouse;

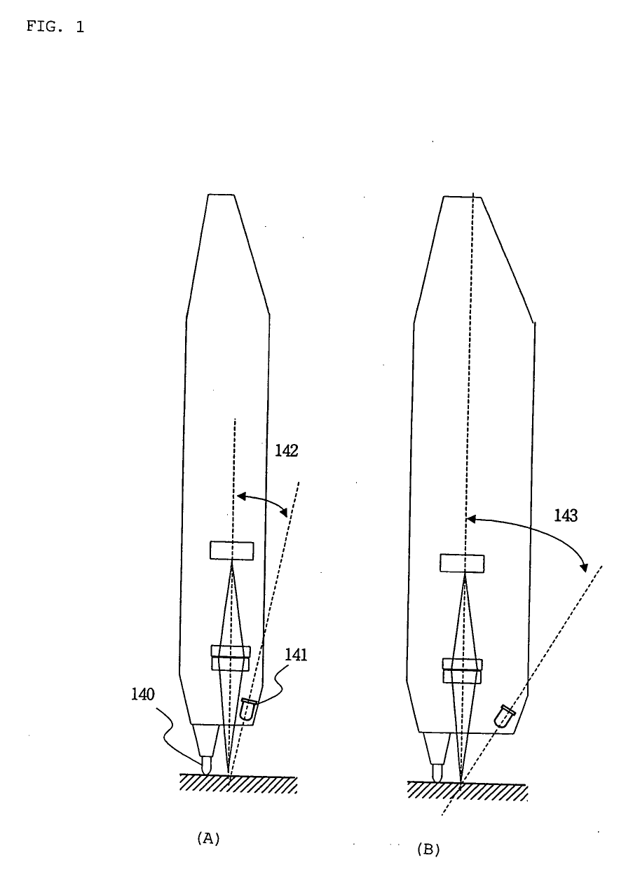

FIGS. 2A and 2B are diagrams schematically illustrating the conventional pen-type mouse of FIG. 1 in an inclined position;

FIGS. 3A and 3B are diagrams schematically illustrating another conventional pen-type mouse;

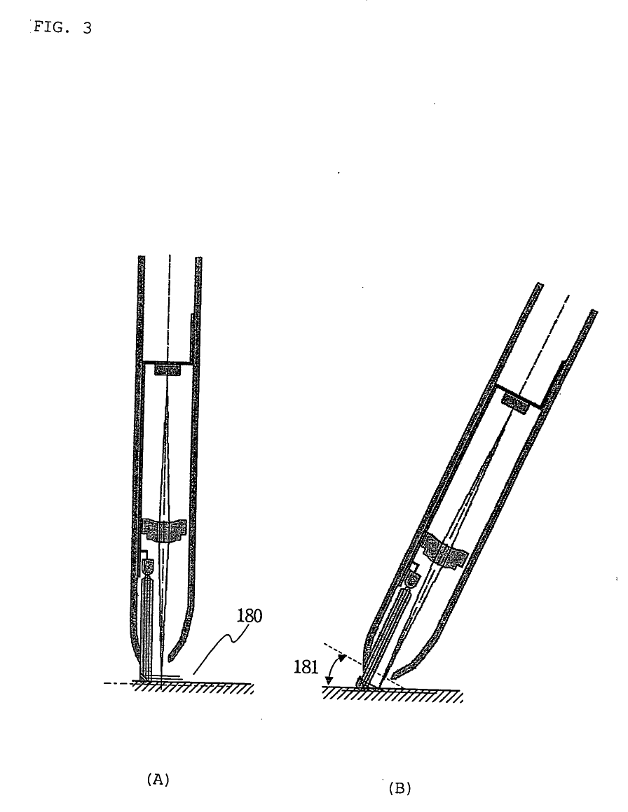

FIGS. 4A and 4B are diagrams schematically illustrating a pen-type mouse according to a first embodiment of the present invention;

FIGS. 5A and 5B are diagrams schematically illustrating a pen-type mouse according to a second embodiment of the present invention;

FIGS. 6A to 6C are diagrams schematically illustrating a pen-type mouse according to a third embodiment of the present invention;

FIGS. 7A and 7B are diagrams illustrating the mounting of the pen-type mouse of the present invention on a mobile terminal and the use of the mobile terminal equipped with the pen-type mouse; and

FIG. 8 is a system configuration diagram of a mobile terminal to which the pen-type mouse of the present invention is applied.

### DESCRIPTION OF THE PREFERRED EMBODIMENTS

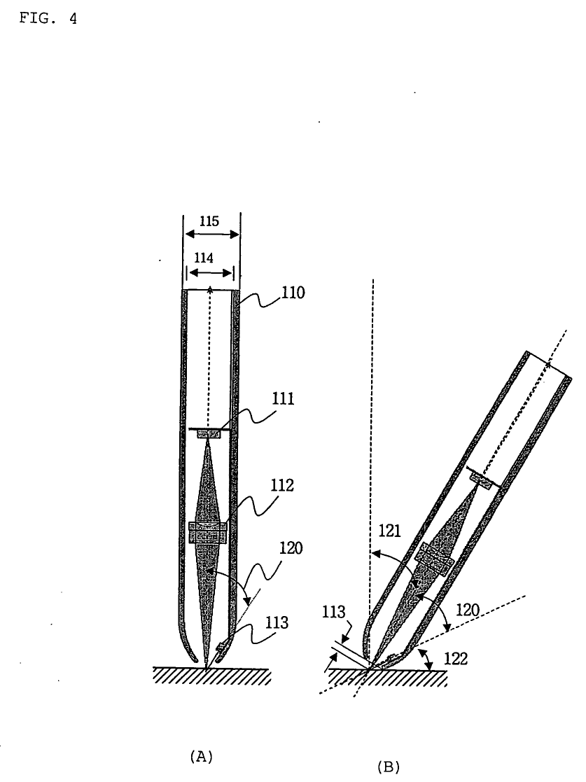

With reference to FIGS. 4A and 4B, a first embodiment of the present invention is described in detail below.

Reference numeral 110 designates the casing of a pen-type mouse, the outer diameter 115 of which is 7.4 mm and the inner diameter 114 of which is 6 mm, so that it can be understood that the size of the pen-type mouse is considerably reduced compared to that of the conventional pen-type mouse (having an output diameter in a range from 17 mm to 21 mm). An optical mouse sensor 111 is formed by attaching a semiconductor wafer-shaped optical mouse sensor on a thin flexible Printed Circuit Board (PCB). Reference numeral 112 designates an optical lens and reference numeral 113 designates a chip LED having a thickness of 0.6 mm.

In the embodiment of FIG. 4A, the angle 120 between the longitudinal axis of the pen-type mouse and the illumination direction of the chip LED 113 is about 35°, so that the angle between the illumination direction of the chip LED 113 and the horizontal axis of the surface is about 55° (90°-35°) Therefore, even in the case where the pen-type mouse is almost vertically used, a somewhat desirable illumination angle with respect to the surface (horizontal surface) can be ensured.

FIG. 4B illustrates an example of an illumination angle in the case where the pen-type mouse is used while remaining inclined. The inclined angle 122 at which the pen-type mouse is used is generally 25°˜40°. In this case, the illumination angle 122 of the chip LED 113 with respect to the horizontal axis of the surface is calculated to be 30°˜50° using the equation (90′-angle 120-angle 121), thus implementing an illumination angle of about 20° that is the optimum angle used in general optical mouse.

Meanwhile, in regard to the implementation of the mechanism of the pen-type mouse, it is possible to implement the pen-type mouse so that the angle between the vertical axis of the mechanism and the illumination axis of the LED 113 is in an angular range from 15° to 60°. However, an angle greater than 50° is not desirable in terms of the design of the lower end of the mechanism. Furthermore, when the sensitivity of the pen-type mouse depending on the angle and the design of the lower end of the mechanism are taken into account, the angle 120 is desirably within an angular range from 30° to 50°.

In the first embodiment of the present invention shown in FIGS. 4A and 4B, the end portion of the pen-type mouse is open, so that impurities, such as dust, can enter into the pen-type mouse and the pen-type mouse may not move smoothly along a rough surface and may be caught by the rough surface when the pen-type mouse is brought into contact with and moves along the rough surface. In order to overcome the above-described shortcomings, a round lower-end cover 130 made of transparent material (transparent plastic or transparent glass) is attached to the lower end of a pen-type mouse in the second embodiment of the present invention. The lower-end cover 130 directly comes into contact with a surface or a pointing detection region, and allows the pen-type mouse to smoothly slide along a contact surface regardless of the inclined position of the pen-type mouse during a pointing operation because it is made of transparent material and is formed in a round shape.

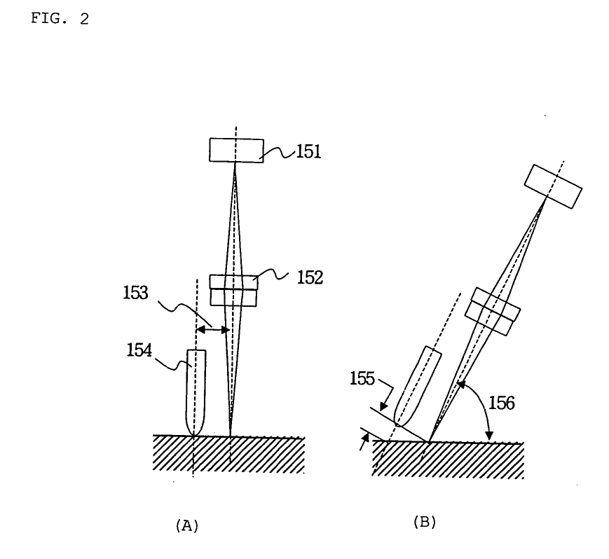

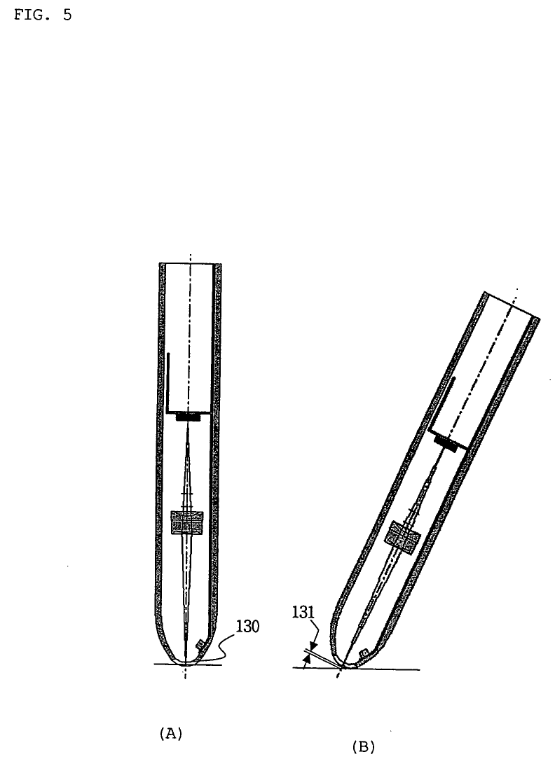

Furthermore, as has been described in conjunction with FIGS. 2A and 2B, in the prior art, the distance between the surface or pointing detection region and an optical image varies considerably depending upon the inclination angle of the pen-type mouse when the pen-type mouse is used, thus causing the degradation of sensitivity of the pen-type mouse. In the embodiment of the present invention shown in FIGS. 5A and 5B, if it is assumed that the lower-end cover 130 has a diameter of 4 mm (a radius of 2 mm) and the inclined angle of the pen-type mouse is 25° when the pen-type mouse is used, the variation in distance 131 is 2 mm/cosine(25°)−2 mm=0.21 mm, which is considerably less than that (0.7 mm) of the prior art. Accordingly, when the pen-type mouse shown in FIGS. 5A and 5B is used, more stable pointing sensitivity can be ensured regardless of the inclined angle of the pen-type mouse that is formed during use.

In the meantime, even though the lower-end cover 130 made of round, transparent material causes slight distortion such that the size of the image of a detection region is reduced, it does not influence general pointing work. When needed, the distortion can be compensated for by adjusting the displacement data output from the optical mouse sensor. The lower-end cover may be designed to have a function of compensating for a distorted image by making the curvatures of the inside and outside of the lower-end cover somewhat different from each other. Furthermore, the distortion is considerably less than the distortion of a detection region that occurs when the general pen-type mouse (see FIGS. 2A and 2B) is used while held inclined. A precise pointing function can be implemented by adjusting the ratio of displacement data at the time of compensating for the distortion.

Furthermore, in the embodiments shown in FIGS. 4 and 5, the distance between the pointing detection region of a surface and an illumination device is reduced compared to the conventional pen-type mouse using a tip point, so that it is possible to use a chip LED the amount of light of which is less than that of the LED used in the conventional pen-type mouse, thus minimizing the lower end of the pen-type mouse of the present invention. Instead of using the LED, the present invention may use a slender optical guide (a slender tube the inside of which is coated with reflective material that reflects light) so as to allow light to be radiated from the lower end of the pen-type mouse of the present invention.

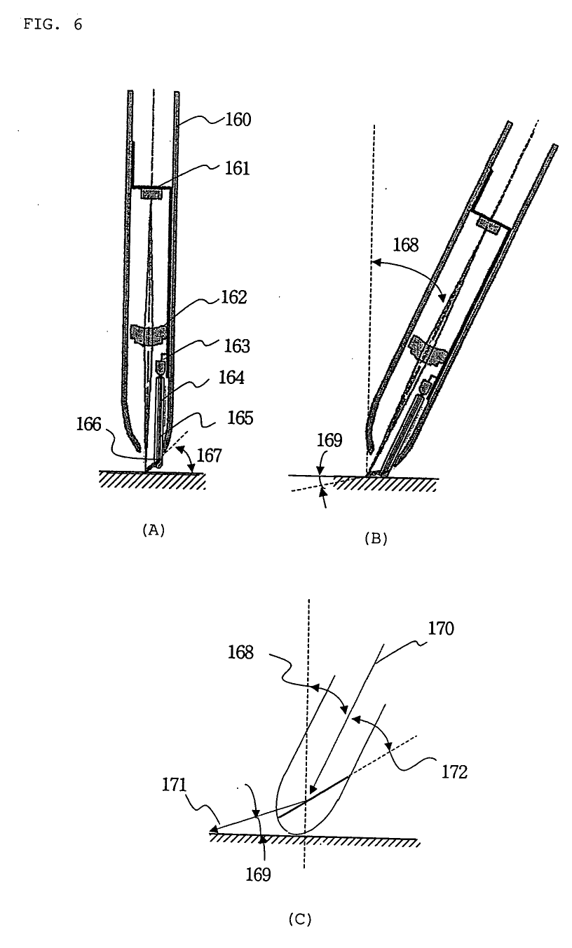

Now, a third embodiment of the present invention is described with reference to FIGS. 6A to 6C.

FIGS. 6A to 6C illustrate a pen-type mouse, in which an optical guide, which transfers the light of an LED, is mounted at the lower end of the pen-type mouse, is used while being in contact with a surface, and functions as a tip point. Reference numeral 160 designates the external casing of the pen-type mouse, reference numeral 161 designates an optical image sensor, reference numeral 163 designates an LED, and reference numeral 164 designates an optical guide. The optical guide 164 is designed such that the upper end thereof has a round lens feature so as to make light entering from the LED linear and the lower end thereof is coated so as to function as a reflective mirror 166 and, therefore, reflect light at a predetermined angle. Reference numeral 165 designates an example of a light path through which light is transferred, and reference numeral 167 designates the inclined angle of the reflective mirror 166 that is formed at the lower end of the optical guide 164. Reference numeral 168 designates the inclined angle of the pen-type mouse when the pen-type mouse is used, and reference numeral 169 designates the angle of illumination that is radiated onto a surface or detection region.

FIG. 6C is an enlarged view of the low end portion of the optical guide 164. Reference numeral 170 designates the path of the light of the LED entering into the optical guide 164, reference numeral 171 designates light reflected by the reflective mirror 166 and radiated onto a surface, and reference numeral 172 designates the angle between the central axis of the optical guide 164 and the reflective surface of the reflective mirror 166. The angle 172 between the reflective mirror 166 and the central axis of the optical guide 164 that allows the pen-type mouse to be inclined at an angle of 25° during use and causes the angle 171 of the light radiated onto a surface to be an optimum angle, that is, 20°, is 90°−((angle 171+angle 168+90°)/2)=22.5°. When the angle 172 of the reflective mirror is in a range from 30° to 15° in the case where the inclined angle 168 of the pen-type mouse during use is in a range from 10°to 40°, illumination light can be radiated onto a detection surface at an angle of about 20°.

Meanwhile, as can be understood from FIG. 6A, even in the case where the pen-type pointing device is used in a vertical position, an illumination angle is ensured to some degree, so that the sensitivity of the pen-type mouse is not degraded.

Furthermore, in order to reduce the size of the pointing device, a method of attaching a chip LED into an element having a tip point function instead of using the optical guide of FIGS. 6A to 6C may be employed. In order to achieve the above-described illumination angle, the chip LED is mounted such that the angle between the chip LED and the central line of the tip point is in a range from 15° to 60°.

In the meantime, although in the above-described embodiments, the chip LED or optical guide is employed, it can be readily understood that it is possible to employ optical fiber instead of them.

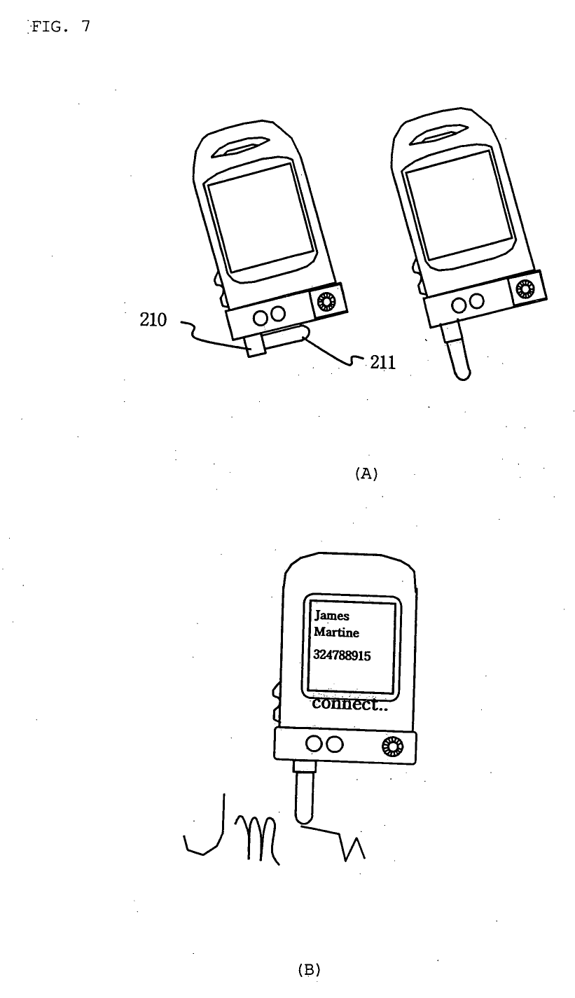

Now, FIGS. 7A and 7B illustrate an example in which the pen-type mouse proposed in the present invention is applied to a mobile terminal.

Referring to FIG. 7A, a pointing device 211 is connected to a hinge 210, which forms a folding structure. In the case of a recently marketed mobile terminal, an antenna does not protrude from a main body but is contained inside the main body. In this case, the pointing device 211 may not be folded.

FIG. 7B illustrates an example in which the initial characters of a name are written using the pointing device 211, the name is recognized, and a telephone number corresponding to the name stored in the mobile terminal is dialed. Of course, it is possible to allow a full name to be written and recognize the full name.

Furthermore, the pointing device of the present invention may be used as a pointing device with which to select a functional icon in such a way as to locate a cursor indicating a pointing position at the functional icon shown on the display of a mobile terminal, and press the pointing device using a predetermined amount of force or activate the functional icon using other button devices. Furthermore, the pointing device of the present invention may be used as a pointing device for an arcade game played on a mobile terminal. Therefore, the range of application of the pointing device of the present invention is very wide.

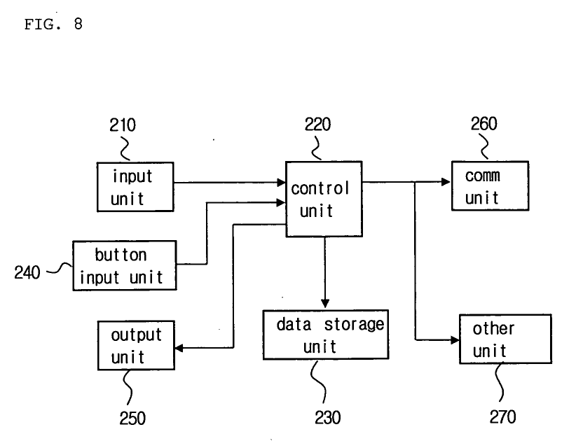

FIG. 8 is a system block diagram of a mobile terminal equipped with the pointing device according to the present invention. Reference numeral 210 designates an input unit that is composed of the pointing device of the present invention that is attached to the mobile terminal. The input unit 210 transfers pointing data, including x and y displacement data in lateral and transverse directions, to a control unit 220. Reference numeral 220 designates the control unit, including the Central Processing Unit (CPU) of the mobile terminal. The control unit 220 processes data so as to recognize written characters using pointing data input from the input unit 210, utilize a cursor indicating a location on a screen as moving data, or have a pointing function on the game of the mobile terminal. A data storage unit 230 stores data that are required to put the pointing data into application. Reference numeral 240 designates a button input unit that relates to a variety of operational buttons arranged on the surface of the mobile terminal. The pressing of buttons is converted into information and is then transferred to the control unit 220. Reference numeral 250 designates an output unit, including a display that recognizes input characters and displays the input characters. Reference numeral 260 designates a communication unit that receives and transmits data to perform the original functions of the mobile terminal. Reference numeral 270 designates some other unit, including an interface that can connect with a digital camera and external devices.

If the pen-type pointing device constructed as described above is employed, the lower-end portion thereof can be reduced while an illumination angle used in existing optical mice can be maintained, so that it is possible to provide a pen-type pointing device having the same size as an existing writing pen.

Furthermore, the present invention minimizes the distance between a pointing detection region and an illumination light without using a tip point at the lower end of the pen-type pointing device, so that it is possible to provide a pen-type pointing device having superior pointing sensitivity.

Furthermore, a round, transparent element is mounted on the lower end of the pointing device that comes into contact with a surface when the pen-type pointing device operates, so that a smooth feeling can be experienced when using the pen-type pointing device of the present invention compared to when using the conventional pen-type pointing device having a tip point and so that the infiltration of dust and impurities into the pen-type pointing device can be prevented.

Furthermore, the optical guide is constructed to have functions of illumination transfer and tip pointing, so that an inclined illumination angle of about 20° is established with respect to a detection region (the bottom of the device, the surface, etc.) and, thus, it is possible to provide a pointing device having superior pointing sensitivity.

Additionally, it is possible to provide a method of maximizing the efficiency of use of light by minimizing the distance between a pointing detection region and an illumination device without using a tip point.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A pen-type optical pointing device, the pen-type optical pointing device detecting a moving direction and distance thereof in such a way as to radiate light onto a plane, detect an image of the plane and analyze a difference between a previous image and a current image, comprising:
a casing configured for a lower portion thereof to converge toward a central axis thereof, with an opening being provided at a lower end thereof; and
an illumination device installed inside the casing, near the opening of the casing and on an acutely inclined side of the casing to have an illumination angle ranging from 15° to 60° with respect to the vertical axis of the pointing device.

2. The pen-type optical pointing device as set forth in claim 1, further comprising a convex, transparent cover that is mounted in the opening to come into contact with the plane.

3. The pen-type optical pointing device as set forth in claim 2, wherein the transparent cover is made of plastic.

4. The pen-type optical pointing device as set forth in claim 2, wherein the transparent cover is made of glass.

5. The pen-type optical pointing device as set forth in claim 1, wherein the illumination device is a chip Light Emitting Diode (LED).

6. The pen-type optical pointing device as set forth in claim 1, wherein the illumination device comprises a guide tube that guides illumination light.

7. The pen-type optical pointing device as set forth in claim 1, wherein the illumination device comprises an optical fiber that guides illumination light.

8. A pen-type optical pointing device, the pen-type optical pointing device detecting a moving direction and distance thereof in such a way as to radiate light onto a plane, detect an image of the plane and analyze a difference between a previous image and a current image, comprising:
a casing configured for a lower portion thereof to gradually converge toward a central axis thereof, with an opening being provided at a lower end thereof; and
a tip point configured to protrude through a portion of the opening located on a side toward which the pen-type pointing device is inclined, come into contact with the plane at a bottom thereof, radiate illumination light in a direction opposite to a direction in which the pen-type pointing device is inclined, and have an illumination angle ranging from 15° to 60° with respect to the central axis of the tip point.

9. The pen-type optical pointing device as set forth in claim 8, wherein the tip point contains a chip LED.

10. The pen-type optical pointing device as set forth in claim 8, wherein the tip point radiates illumination light through an inner optical fiber.

11. The pen-type optical pointing device as set forth in claim 8, wherein the tip point is formed of an optical guide.

12. The pen-type optical pointing device as set forth in claim 11, wherein the optical guide is provided with a reflective mirror that is inclined within an angular range from 15° to 30°.

13. A mobile communication terminal equipped with the pen-type optical pointing device as set forth in claim 1.

14. The mobile communication terminal as set forth in claim 13, wherein the pointing device is installed at a location where a general antenna of the mobile communication terminal is installed.

15. The mobile communication terminal as set forth in claim 13, wherein the pointing device is connected to a main body of the mobile communication terminal through a hinge.
